(19) United States
(12) Patent Application Publication
(10) Pub. No.: US 2015/0199129 A1
(43) Pub. Date: Jul. 16, 2015

(54) System and Method for Providing Data Services in Direct Attached Storage via Multiple De-clustered RAID Pools

(71) Applicant: LSI Corporation, San Jose, CA (US)

(72) Inventor: Naman Nair, Fremont, CA (US)

(73) Assignee: LSI Corporation, San Jose, CA (US)

(21) Appl. No.: 14/181,108

(22) Filed: Feb. 14, 2014

Related U.S. Application Data
(60) Provisional application No. 61/927,361, filed on Jan. 14, 2014.

(51) Int. Cl. G06F 3/06

(52) U.S. Cl. CPC G06F 3/064; G06F 3/0604; G06F 3/0664; G06F 3/0653; G06F 3/0689

(57) ABSTRACT

A system and method for providing Quality of Service (QoS)-based data services in a direct attached storage system including at least one physical drive comprises logically dividing the drive or drives into a plurality of pools implemented according to CRUSH algorithms or other declustered RAID configurations. The plurality of pools are then managed as declustered RAID virtual drives. The system and method further comprises identifying a pool with a performance characteristic and monitoring the pool to detect “hot” data within the pool, which may then be migrated to a pool with a more desirable performance characteristic. The system and method further comprises prioritizing critical operations performed on a pool based on the performance characteristic of the pool.

### CROSS-REFERENCE TO RELATED APPLICATIONS

The present application claims the benefit under 35 U.S.C. §119(e) of U.S. Provisional Application Ser. No. 61/927,361, filed Jan. 14, 2014. Said U.S. Provisional Application is herein incorporated by reference in its entirety.

### TECHNICAL FIELD

The present disclosure generally relates to the field of data storage systems, and more particularly to direct attached storage (DAS) systems.

### BACKGROUND

RAID (Redundant Array of Independent Disks) storage management involves defining logical storage volumes, or virtual drives, comprising multiple physical drives. Storage controllers translate I/O requests directed to a virtual drive into access to the underlying physical drives. Data in a virtual drive is distributed, or striped, across multiple physical drives and redundancy information is added to the data stored in the virtual drive to improve reliability. De-clustered storage systems, e.g., de-clustered RAID (D-RAID) configurations, distribute or stripe data across a single drive, a large set of physical drives, or all physical drives in the system. For example, the combined capacity of all physical storage devices in the system can be managed as one or more pools of storage space. Virtual drives can then be distributed throughout the pool or pools, each virtual drive defined by mapping data blocks of the virtual drive to locations on the physical drives.

Direct attached storage (DAS) refers to data storage environments directly connected to a server, without a storage network (SAN, NAS) in between. A DAS environment may include anywhere from a single disk to a thousand disks. Currently available DAS environments, while potentially more affordable and lower in overall complexity than networked storage environments, may not offer a desired level of functionality with respect to Quality of Service (QoS)-based data services such as storage tiering, I/O latency, or rebuilding failed drive data. Therefore it may be desirable to provide a platform for QoS-based data services in a DAS environment.

### SUMMARY

Accordingly, embodiments of the present invention comprises a system, method, and computer-readable instructions for providing Quality of Service (QoS)-based data services in a direct-attached storage (DAS) environment by logically dividing a plurality of physical drives (ex.—hard disks) within the DAS environment into a plurality of de-clustered RAID (D-RAID) pools, distributing RAID stripes across physical drives in each pool according to D-RAID configurations, Controlled Replication Under Scalable Hashing (CRUSH) algorithms, or other like distribution and striping schemes.

Each D-RAID pool can include a plurality of blocks, each block including a continuous range of physical logical block addresses (LBAs). The resulting plurality of D-RAID pools can then be managed as a plurality of virtual drives. In further embodiments, the method may further comprise identifying a first pool with a first performance characteristic and a second pool with a second performance characteristic. In still further embodiments, the method may further comprise: monitoring the utilization of said first pool to detect hot data within at least one block of the first pool; logically dividing the at least one block into at least a first segment and a second segment; and migrating either the first segment or the second segment into the second pool based on the first performance characteristic and the second performance characteristic. In still further embodiments, the method may comprise prioritizing a critical operation performed on a first pool over a critical operation performed on a second pool based on the first performance characteristic and the second performance characteristic.

It is to be understood that both the foregoing general description and the following detailed description are exemplary and explanatory only and are not necessarily restrictive of the invention as claimed. The accompanying drawings, which are incorporated in and constitute a part of the specification, illustrate embodiments of the invention and together with the general description, serve to explain the principles of the invention.

### BRIEF DESCRIPTION OF THE DRAWINGS

The advantages of the invention may be better understood by those skilled in the art by reference to the accompanying figures in which:

FIG. 1 is a block diagram illustrating a plurality of physical drives;

FIG. 2 is a block diagram illustrating a plurality of D-RAID pools mapped to physical drives in accordance with an embodiment of the present invention;

FIG. 3 is a block diagram illustrating the distribution of virtual drive stripes across a D-RAID pool in accordance with an embodiment of the present invention;

FIG. 4 is a block diagram illustrating data tiering in accordance with an embodiment of the present invention; and

FIGS. 5A through 5F are process flow diagrams illustrating methods of operation in accordance with the present invention.

### DETAILED DESCRIPTION

Features of the present invention in its various embodiments are exemplified by the following descriptions with reference to the accompanying drawings, which describe the present invention with further detail. These drawings depict only selected embodiments of the present invention, and should not be considered to limit its scope in any way.

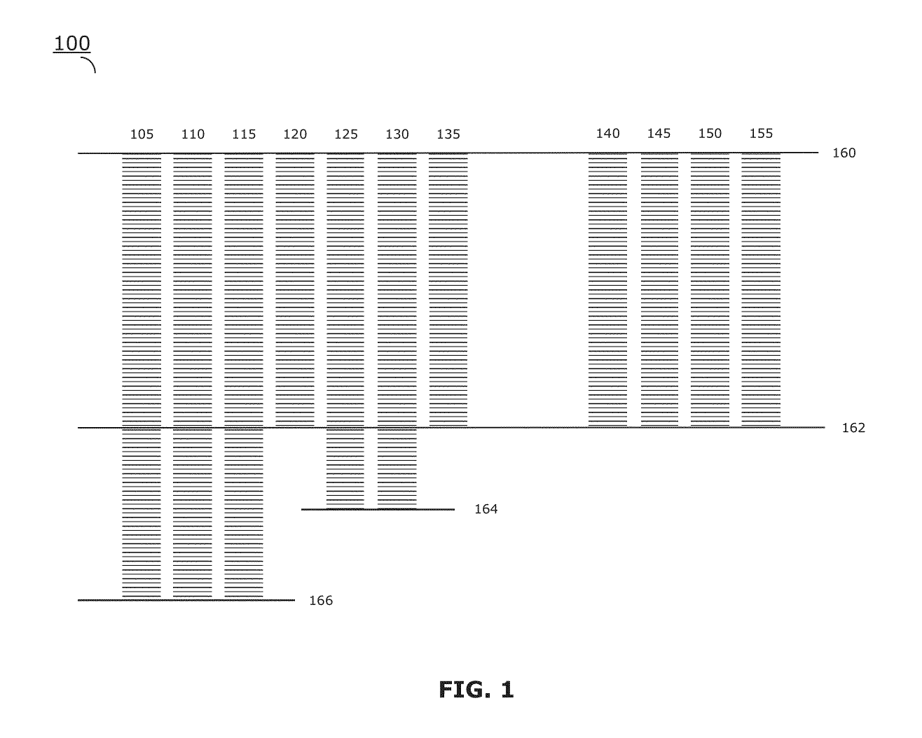

FIG. 1 illustrates an embodiment of a direct-attached storage (DAS) environment 100 operably coupled to a computer, processor, or controller according to the present invention. DAS environment 100 includes physical drives (ex.—hard disks) 105, 110, 115, 120, 125, 130, 135, 140, 145, 150 and 155. In various embodiments, DAS environment 100 can include physical drives of varying size, capacity, operating characteristics, etc. For example, embodiments of DAS environment 100 can include up to one thousand or more physical drives of various capacities. In some embodiments, each physical drive of DAS environment 100 has a capacity of at least 1 TB. Physical drives 120, 140, 145, 150, 155 of DAS environment 100 include a continuous range of physical logical block addresses (LBAs) from LBA 160 to LBA 162. Physical drives 125, 130 further include a continuous range of physical LBAs from LBA 160 to LBA 164, while physical drives 105, 110, 115 include a continuous range of physical LBAs from LBA 160 to LBA 166. Storage space may be available in any continuous range of LBAs contained within embodiments of DAS environment 100. In embodiments, each logical division of a physical drive in DAS environment 100 will include multiple regions or “chunks” of storage space, each “chunk” representing e.g., 256 MB to 1 GB of storage space depending on the capacity of the physical drives and user defined requirements.

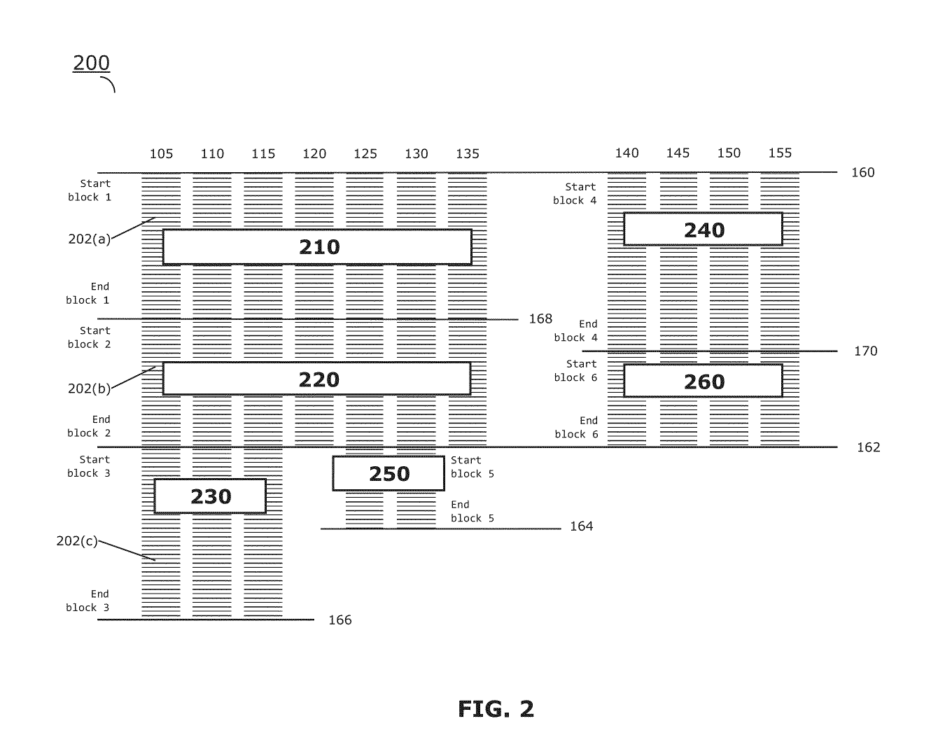

FIG. 2 illustrates an embodiment of direct-attached storage (DAS) environment 200 of the present invention logically divided into pools 210, 220, 230, 240, 250, 260, 270. In some embodiments, DAS environment 200 is logically divided into D-RAID pools according to Controlled Replication Under Scalable Hashing (CRUSH) or other like virtualization or data distribution algorithms. CRUSH algorithms define a cluster of storage devices in terms of a compact cluster map. CRUSH algorithms further view data storage objects as either devices or buckets (ex.—storage containers); a bucket may contain either devices or other buckets, so that the cluster map functions as a hierarchical decision tree. For example, a cluster (ex.—bucket) may contain several rooms, each room containing several rows, each row containing several cabinets, each cabinet containing several devices. Each device may be assigned a weight. CRUSH algorithms then use a pseudorandom mapping function to distribute data uniformly throughout the cluster according to user-defined data placement rules. For example, a placement rule can specify that a particular block of data be stored in the above cluster as three mirrored replicas, each of which is to be placed in a different row. Should a device fail, CRUSH algorithms can redistribute its contents according to placement rules, minimizing data migration in response to a change in the cluster map. CRUSH algorithms provide for a layer of virtualization beyond RAID virtual drives, and allow the migration of data without interrupting the processing of I/O requests from the host system.

Physical drives 105, 110, 115 are logically divided at LBAs 168 and 162 such that block 202(a) of physical drive 105 (representing a continuous range of LBAs, ex.—regions or “chunks” of the physical drive) is allocated to pool 210, block 202(b) of drive 105 is allocated to pool 220, and block 202(c) of drive 105 is allocated to pool 230. In some embodiments, a pool may not contain more than one block from the same physical drive; for example, pool 220 includes blocks of physical drives 105, 110, 115, 120, 125, 130, and 135. Embodiments of DAS environment 200 may logically divide physical drives into a small number of large capacity pools, a large number of small capacity pools, or a broad variety of pool sizes. In some embodiments, each block within a pool may include an identical continuous range of physical LBAs. For example, each block of pool 210 includes a continuous range of identical physical LBAs from LBA 160 to LBA 168, where each block is located on a different physical drive. In embodiments of DAS environment 200, each physical LBA can be mapped to a virtual LBA in accordance with D-RAID configurations, CRUSH algorithms, or the like, the resulting mapping stored within DAS environment 200.

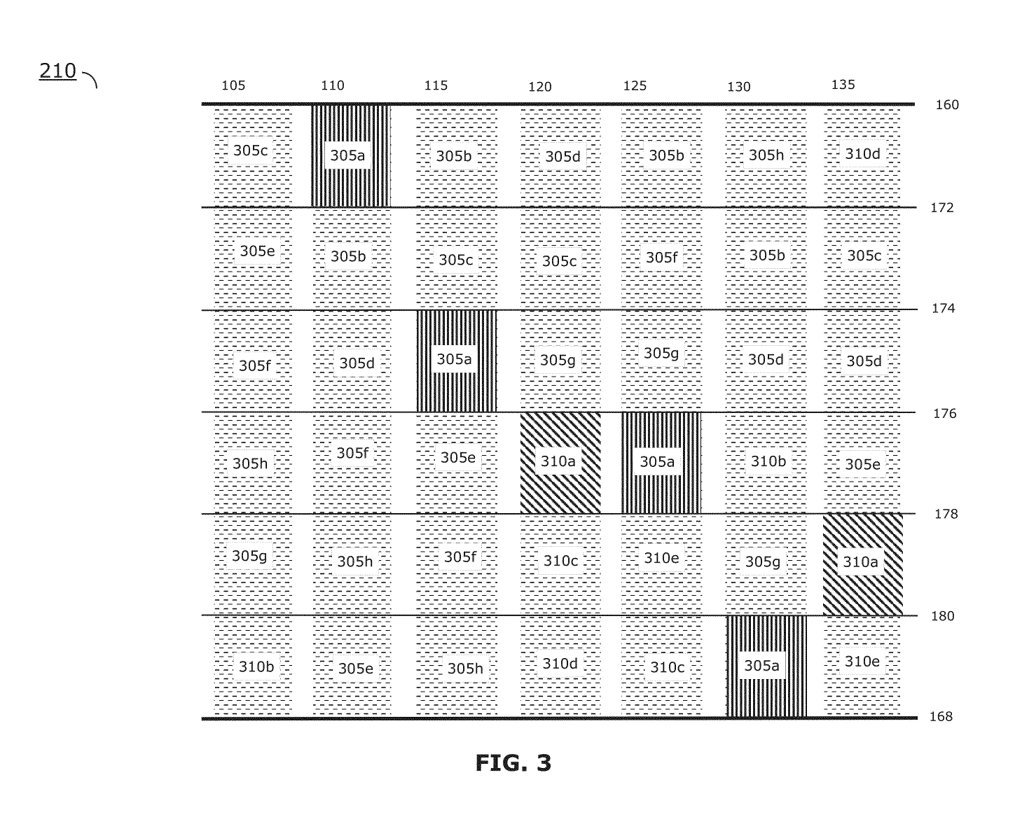

FIG. 3 illustrates an embodiment of D-RAID pool 210 of DAS environment 200 managed as a pair of virtual drives 305, 310 distributed throughout pool 210 (including space on physical drives 105, 110, 115, 120, 125, 130, 135). In embodiments, virtual drives 305 and 310 can be distributed, or striped, across D-RAID pool 210 according to CRUSH algorithms or various RAID configuration schemes (ex.—RAID 0, RAID 1, RAID 5, RAID 6), depending on performance, cost, or redundancy requirements or any other desirable criteria. For example, virtual drive 305 is a RAID virtual drive including eight stripes distributed across four physical drives, i.e., each stripe 305a, 305b, 305c, 305d, 305e, 305f, 305g, 305h will include parts of four physical drives. Virtual drive 310 is a RAID virtual drive of five stripes 310a, 310b, 310c, 310d, 310e similarly distributed across two physical drives. Rather than stripe data sequentially across physical drives as in a traditional RAID environment, pool 210 is logically divided into blocks at LBAs 172, 174, 176, 178, and 180 and the stripes of virtual drives 305 and 310 are distributed according to CRUSH or like algorithms. In various embodiments, the division and distribution of D-RAID pools can include division into a small number of comparatively large blocks (e.g, dividing physical drive 105 into six blocks of 100 GB each), a vast number of comparatively small blocks, or any configuration in between. According to various algorithms and placement rules, D-RAID stripe 305a is mapped to pool 210 as follows: physical drive 110 (the continuous range between LBAs 160 and 172), physical drive 115 (the continuous range between LBAs 174 and 176), physical drive 125 (the continuous range between LBAs 176 and 178), and physical drive 130 (the continuous range between LBAs 180 and 168). Similarly, D-RAID stripe 310a is mapped to physical drives 120 (between LBAs 176 and 178) and 135 (between LBAs 178 and 180). D-RAID stripes 305b . . . 305h of virtual drive 305 and RAID stripes 310b . . . 310e of virtual drive 310 are similarly distributed according to the selected algorithms. In embodiments, the virtual LBAs of virtual drives are decoupled from the physical LBAs of physical drives. Therefore the association of physical LBAs to virtual LBAs can be dynamic, rather than fixed as in a traditional RAID or DAS environment. Each virtual LBA can then be mapped to a physical LBA within DAS environment 200 and the resulting mapping stored within DAS environment 200 according to the selected algorithms or configurations. In some embodiments of DAS environment 200, virtual drives may include blocks of data from more than one pool.

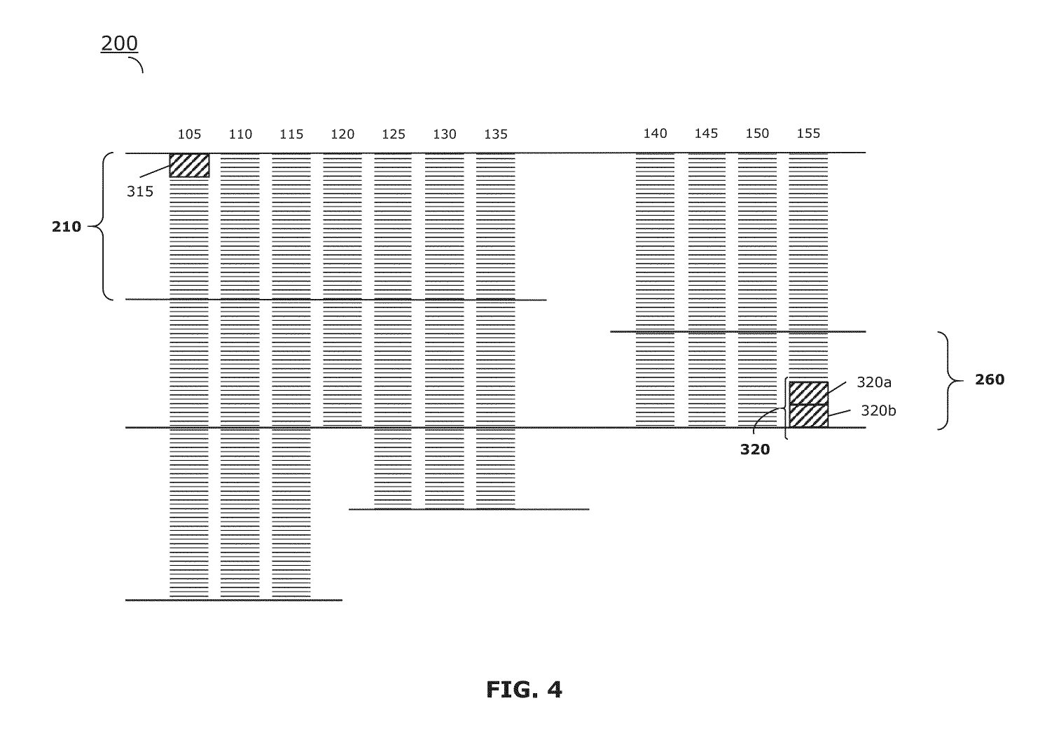

FIG. 4 illustrates an embodiment of DAS environment 200 managed as a plurality of virtual drives in which data tiering operations are performed. In embodiments, managing DAS environment 200 as a plurality of virtual drives in D-RAID pools provides a platform for Quality of Service (QoS)-based data services (e.g., data tiering) in DAS. Use of D-RAID pools and striping enables many operations on a virtual drive to occur in parallel, thereby reducing the time required to perform these operations. In embodiments, one or more D-RAID pools can be targeted to perform specific QoS operations or critical operations such as I/O latency, rebuilding failed drive data, etc., and addressed first. The remainder of DAS environment 200 can thereby be shielded from the larger consequences of drive failures, disk thrashing latency, etc. In embodiments, once LBAs are decoupled, portions of a virtual drive may be identified as “hot” or “cold” data depending on frequency of access. In embodiments, individual D-RAID pools can be associated with a performance characteristic in order to provide a platform for data tiering and other QoS operations. For example, pool 210 of DAS environment 200 can be assigned a desirable performance characteristic associated with low latency. Pool 260 can be assigned a less desirable performance characteristic associated with higher latency. Data within block 320 of pool 260 is identified as “hot” (ex.—high frequency of access) or “cold” (ex.—low frequency of access); block 320 is then divided into segments 320(a) and 320(b), where segment 320(a) includes a proportionally larger amount of “hot” data. Free storage space is available within segment 315 of pool 210. In embodiments, if pool 210 has a more desirable performance characteristic (ex.—low latency) than pool 260, segment 320(a) is migrated to block 315 of pool 210 while segment 320(b) is retained in pool 260. Similarly, if pool 210 has a less desirable performance characteristic than pool 260, segment 320(b) is migrated to block 315 of pool 210 while segment 320(a) is retained in pool 260.

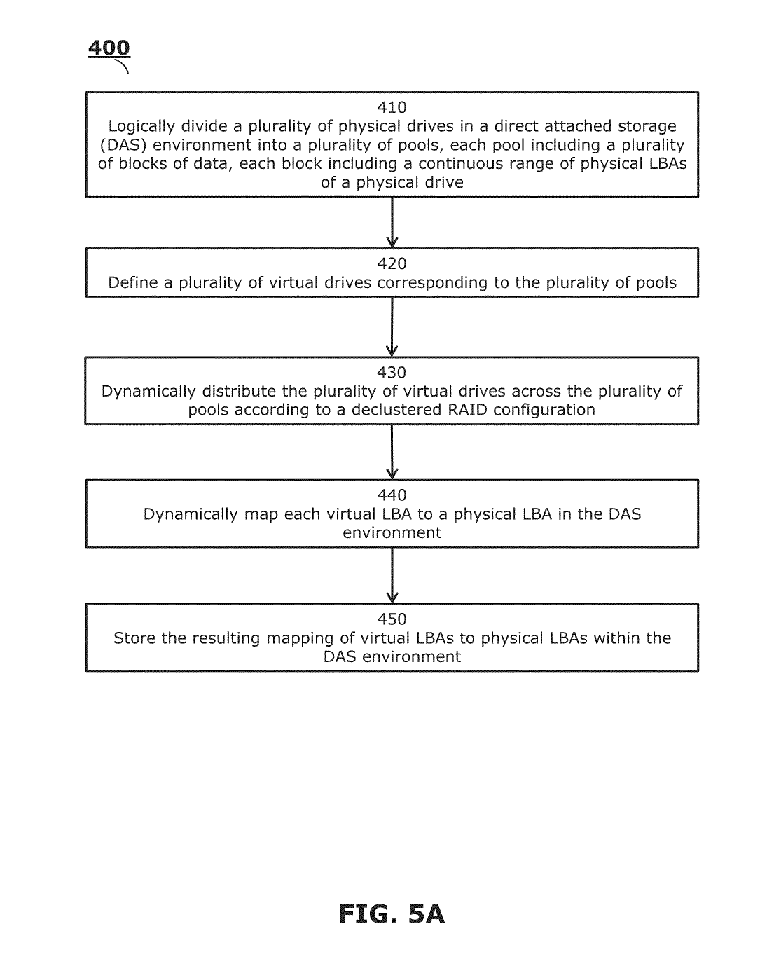

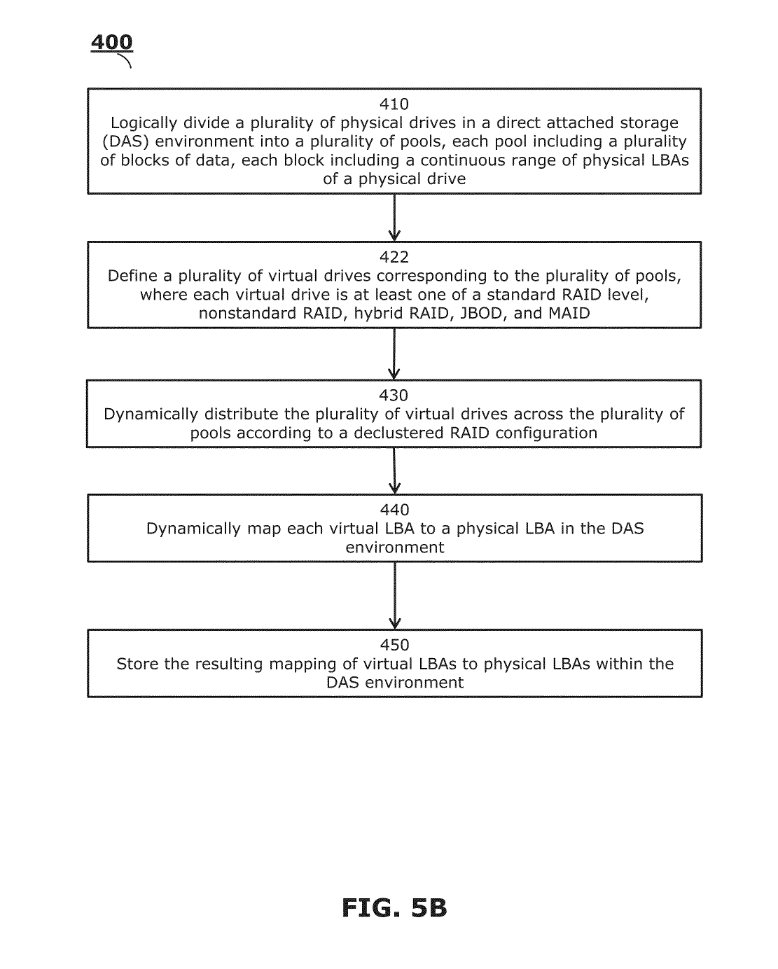

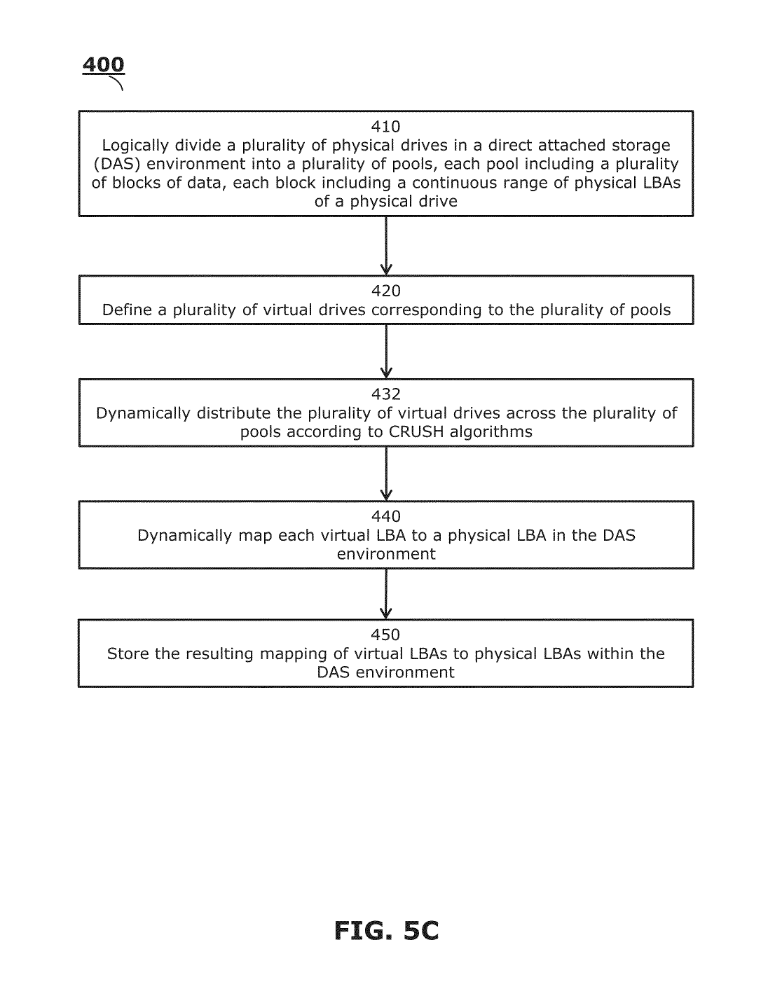

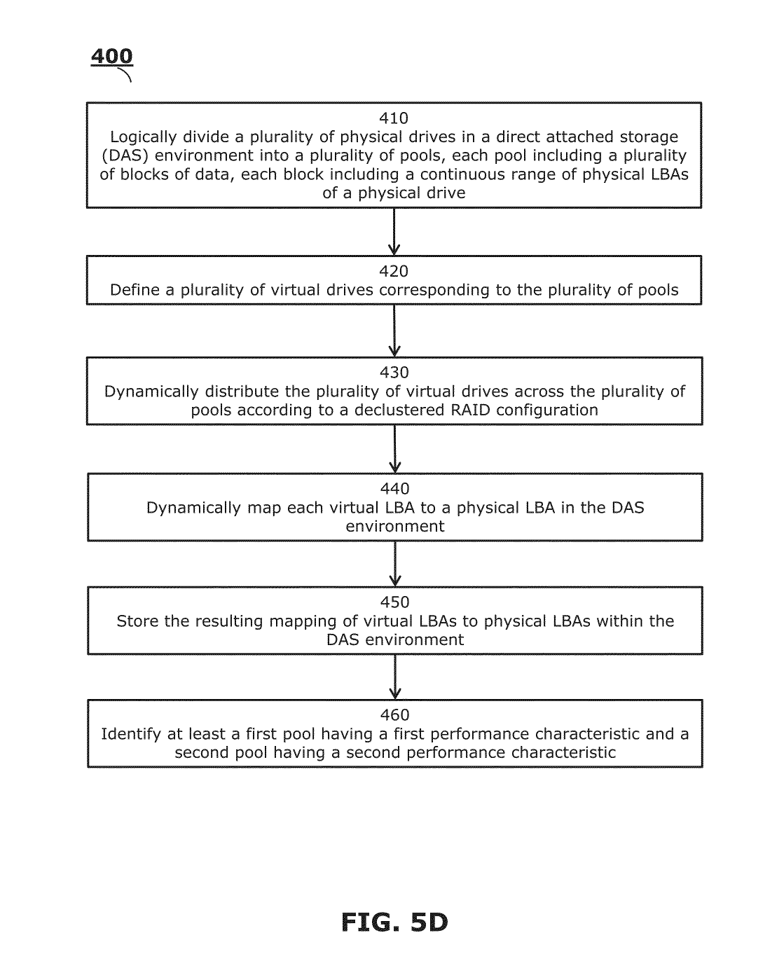

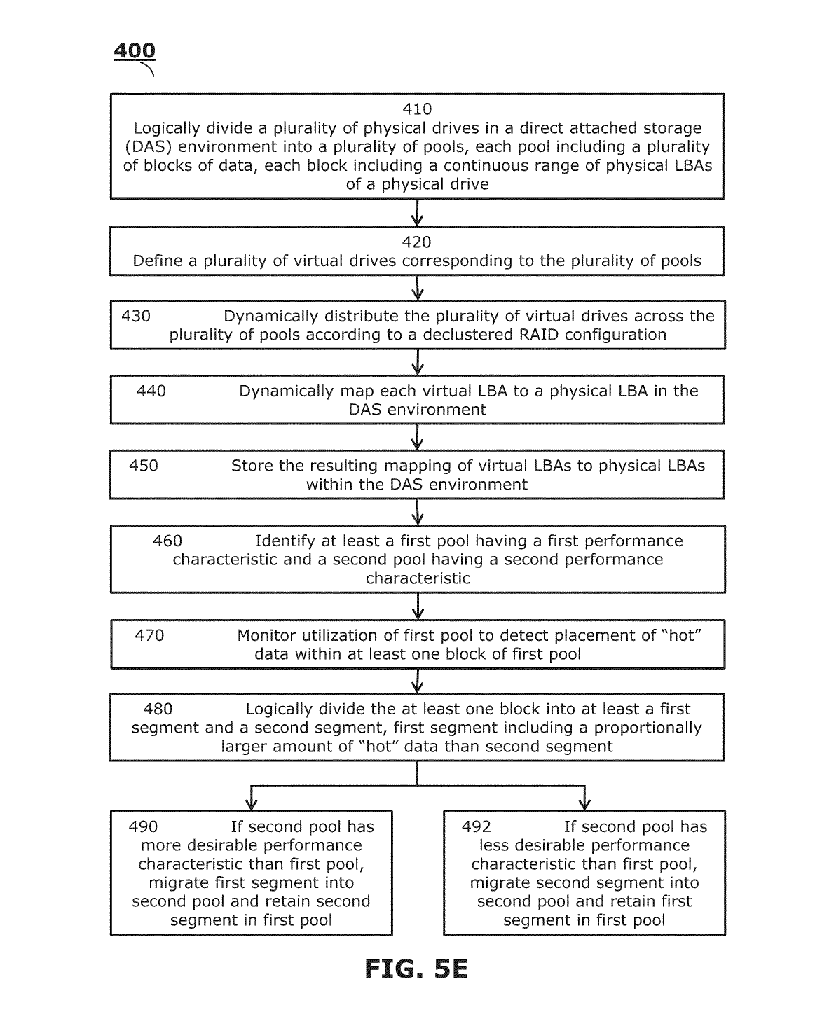

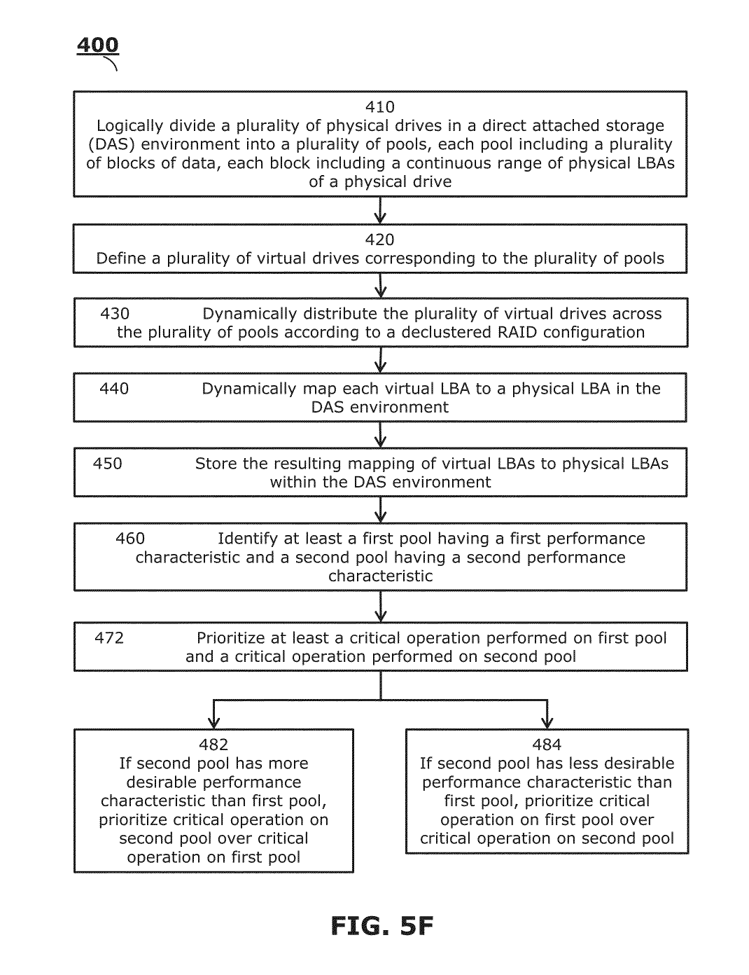

FIGS. 5A through 5F illustrate a method 400 executable by a processor or controller for implementing multiple declustered Redundant Array of Independent Disks (RAID) pools, or D-RAID pools, in a direct-attached storage (DAS) environment 200 including a plurality of physical drives operably coupled to a controller (ex.—processor, computing device). Referring to FIG. 5A, at step 410 the controller logically divides the plurality of physical drives into a plurality of pools, each pool including a plurality of blocks, each block including a continuous range of physical LBAs. At step 420, the controller defines a plurality of virtual drives corresponding to the plurality of pools. At step 430, the controller dynamically distributes the plurality of virtual drives across the plurality of pools according to a de-clustered RAID configuration. At step 440, the controller dynamically maps each virtual LBA of DAS environment 200 to a physical LBA in DAS environment 200. At step 550, the controller stores the resulting mapping of virtual LBAs to physical LBAs within DAS environment 200.

Referring to FIG. 5B, method 400 may include additional step 422. At step 422, the controller defines a plurality of drives corresponding to the plurality of pools, where each virtual drive is at least one of a standard RAID configuration (e.g., RAID 0, RAID 1, RAID 5, RAID 6, etc.), a nonstandard RAID configuration, a hybrid RAID configuration, just a bunch of disks (JBOD), and a massive array of idle drives (MAID).

Referring to FIG. 5C, method 400 may include additional step 432. At step 432, the controller dynamically distributes the plurality of virtual drives across the plurality of pools according to Controlled Replication Under Scalable Hashing (CRUSH) algorithms.

Referring to FIG. 5D, method 400 may include additional step 460. At step 460, the controller identifies at least a first pool with a first performance characteristic and a second pool with a second performance characteristic. In embodiments, a performance characteristic may include at least one of, but is not limited to, latency, input/output operations per second (IOPS), and bandwidth.

Referring to FIG. 5E, method 400 may include additional steps 470, 480, 490, and 492 for providing data tiering in embodiments of DAS environment 200. At step 470, the controller monitors utilization of the first pool to detect placement of “hot” (ex.—high frequency of access) data within at least one block of the first pool. In embodiments, the controller may alternatively detect placement of “cold” (ex.—low frequency of access) data within at least one block of the first pool. At step 480, the controller logically divides the at least one block into at least a first segment and a second segment, the first segment including a proportionally larger amount of “hot” data than the second segment. At step 490, if the second pool has a more desirable performance characteristic than the first pool, the controller will migrate the first segment into the second pool and retain the second segment in the first pool. At step 492, if the second pool has a less desirable performance characteristic than the first pool, the controller will migrate the second segment into the second pool and retain the first segment in the first pool.

Referring to FIG. 5F, method 400 may include additional steps 472, 482, and 484 for prioritizing critical operations in DAS environment 200. At step 472, the controller prioritizes at least a critical operation performed on the first pool and a critical operation performed on the second pool. In embodiments, a critical operation can include, but is not limited to, at least one of an I/O operation and the rebuilding of failed drive data. At step 482, if the second pool has a more desirable performance characteristic than the first pool, the controller prioritizes a critical operation performed on the second pool over a critical operation performed on the first pool. At step 484, if the second pool has a less desirable performance characteristic than the first pool, the controller prioritizes a critical operation performed on the first pool over a critical operation performed on the second pool.

Those having skill in the art will appreciate that there are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; alternatively, if flexibility is paramount, the implementer may opt for a mainly software implementation; or, yet again alternatively, the implementer may opt for some combination of hardware, software, and/or firmware. Hence, there are several possible vehicles by which the processes and/or devices and/or other technologies described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary. Those skilled in the art will recognize that optical aspects of implementations will typically employ optically-oriented hardware, software, and or firmware.

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “connected”, or “coupled”, to each other to achieve the desired functionality, and any two components capable of being so associated can also be viewed as being “couplable”, to each other to achieve the desired functionality. Specific examples of couplable include but are not limited to physically mateable and/or physically interacting components and/or wirelessly interactable and/or wirelessly interacting components and/or logically interacting and/or logically interactable components.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein.

We claim:

1. A system for providing direct attached storage, comprising:
at least one physical drive, each physical drive including a plurality of blocks, each block including a continuous range of physical logical block addresses;
a plurality of pools implemented according to at least one declustered Redundant Array of Independent Disks (RAID) configuration, each pool including a plurality of virtual logical block addresses and at least one block of the plurality of blocks;
at least one controller operably coupled to the at least one physical drive, configured to manage the plurality of pools as a plurality of virtual drives according to the at least one declustered RAID configuration.

2. The system of claim 1, wherein the plurality of pools implemented according to at least one declustered Redundant Array of Independent Disks (RAID) configuration includes
a plurality of pools implemented according to Controlled Replication under Scalable Hashing (CRUSH) algorithms.

3. The system of claim 1, wherein the at least one controller is further configured to
dynamically map the physical LBA of each block of the plurality of virtual drives to a virtual LBA; and
store the resulting map of physical LBAs to virtual LBAs within the at least one physical drive.

4. The system of claim 1, wherein the at least one controller is configured to manage each virtual drive of the plurality of virtual drives in at least one of a standard RAID configuration, a nonstandard RAID configuration, a hybrid RAID configuration, a just-a-bunch-of-disks (JBOD) configuration, and a massive array of idle drives (MAID) configuration.

5. The system of claim 1, wherein the at least one controller is configured to
identify at least a first pool and a second pool of the plurality of pools, the first pool having a first performance characteristic including at least one of input/output operations per second, latency, and bandwidth and the second pool having a second performance characteristic including at least one of input/output operations per second, latency, and bandwidth.

6. The system of claim 5, wherein the at least one controller is further configured to
monitor the utilization of the first pool to detect the placement of frequently accessed data within at least one block of the pool;
logically divide the at least one block into at least a first segment and a second segment, the first segment including a proportionally larger amount of frequently accessed data than the second segment; and
migrate the first segment into the second pool and retain the second segment in the first pool when the second pool has a more desirable performance characteristic than the first pool, and migrate the second segment into the second pool and retain the first segment in the first pool when the second pool has a less desirable performance characteristic than the first pool.

7. The system of claim 5, wherein the at least one controller is configured to prioritize a critical operation performed on at least one of the first pool and the second pool based on the performance characteristic.

8. The system of claim 7, wherein the at least one controller is further configured to prioritize a critical operation performed on the first pool over a critical operation performed on the second pool when the first pool has a more desirable performance characteristic than the second pool and prioritize a critical operation performed on the second pool over a critical operation performed on the first pool when the first pool has a less desirable performance characteristic than the second pool.

9. The system of claim 7, wherein the critical operation includes at least one of an I/O operation and rebuilding failed drive data.

10. The system of claim 1, wherein the system is embodied in a Redundant Array of Independent Disks (RAID) system comprising at least one hard disk.

11. A method for providing direct attached storage via at least one physical drive, executable by a computer or processor operably coupled to the at least one physical drive, comprising:
logically dividing the at least one physical drive into a plurality of pools according to at least one declustered Redundant Array of Independent Disks (RAID) configuration, each pool including a plurality of virtual logical block addresses and a plurality of blocks, each block including a continuous range of physical logical block addresses; and
managing the plurality of pools as a plurality of virtual drives according to the at least one declustered RAID configuration.

12. The method of claim 11, wherein
logically dividing the at least one physical drive into a plurality of pools according to at least one declustered Redundant Array of Independent Disks (RAID) configuration includes logically dividing the at least one physical drive into a plurality of pools according to Controlled Replication under Scalable Hashing (CRUSH) algorithms; and
managing the plurality of pools as a plurality of virtual drives according to the at least one declustered RAID configuration includes managing the plurality of pools as a plurality of virtual drives according to Controlled Replication under Scalable Hashing (CRUSH) algorithms.

13. The method of claim 11, wherein managing the plurality of pools as a plurality of virtual drives according to the at least one declustered RAID configuration includes:
dynamically mapping each physical LBA of each block of each virtual drive to a virtual LBA; and
storing the resulting map of physical LBAs to virtual LBAs within the at least one physical drive.

14. The method of claim 11, wherein managing the plurality of pools as a plurality of virtual drives according to the at least one declustered RAID configuration includes managing the plurality of virtual drives in at least one of a standard RAID configuration, a nonstandard RAID configuration, a hybrid RAID configuration, a just-a-bunch-of-disks (JBOD) configuration, and a massive array of idle drives (MAID) configuration.

15. The method of claim 11, further comprising:
identifying at least a first pool and a second pool of the plurality of pools, the first pool having a first performance characteristic including at least one of input/output operations per second, latency, and bandwidth and the second pool having a second performance characteristic including at least one of input/output operations per second, latency, and bandwidth.

16. The method of claim 15, further comprising:
monitoring the utilization of the first pool to detect the placement of frequently accessed data within at least one block of the pool;
logically dividing the at least one block into at least a first segment and a second segment, the first segment including a proportionally larger amount of frequently accessed data than the second segment; and
migrating the first segment into the second pool and retaining the second segment in the first pool when the second pool has a more desirable performance characteristic than the first pool, and migrating the second segment into the second pool and retaining the first segment in the first pool when the second pool has a less desirable performance characteristic than the first pool.

17. The method of claim 15, further comprising:
prioritizing a critical operation performed on at least one of the first pool and the second pool based on the performance characteristic.

18. The method of claim 17, wherein prioritizing a critical operation performed on at least one of the first pool and the second pool includes prioritizing a critical operation performed on the first pool over a critical operation performed on the second pool when the first pool has a more desirable performance characteristic than the second pool and prioritizing a critical operation performed on the second pool over a critical operation performed on the first pool when the first pool has a less desirable performance characteristic than the second pool.

19. The method of claim 17, wherein the critical operation includes at least one of an I/O operation and rebuilding failed drive data.

20. An article of manufacture comprising a computer-readable, non-transitory medium bearing encoded instructions executable by a computer or processor operably coupled to a direct attached storage system including at least one physical drive for:
logically dividing the at least one physical drive into a plurality of pools according to at least one declustered Redundant Array of Independent Disks (RAID) configuration, each pool including a plurality of virtual logical block addresses and a plurality of blocks, each block including a continuous range of physical logical block addresses;
managing the plurality of pools as a plurality of virtual drives according to the at least one declustered RAID configuration;
identifying at least a first pool and a second pool of the plurality of pools, the first pool having a first performance characteristic and the second pool having a second performance characteristic;
monitoring the utilization of the first pool to detect the placement of frequently accessed data within at least one block of the pool;
logically dividing the at least one block into at least a first segment and a second segment, the first segment including a proportionally larger amount of frequently accessed data than the second segment;
migrating at least one of the first segment and the second segment into the second pool based on at least one performance characteristic; and
prioritizing a critical operation performed on at least one of the first pool and the second pool based on the performance characteristic.
